(19) United States
(12) Patent Application Publication
(10) Pub. No.: US 2025/0043621 A1
(43) Pub. Date: Feb. 6, 2025

(54) INTELLIGENT DOOR SCREEN SYSTEM FOR PROVIDING SAFETY AND SECURITY

(71) Applicant: SPDR INNOVATIONS LLC, Winter Garden, FL (US)

(72) Inventors: Djuan L. Rivers, Winter Garden, FL (US); Steven J. Porter, Winter Garden, FL (US)

(21) Appl. No.: 18/789,489

(22) Filed: Jul. 30, 2024

Related U.S. Application Data
(60) Provisional application No. 63/529,929, filed on Jul. 31, 2023.

(51) Int. Cl. E06B 7/30; G06V 20/52; G06V 40/16; G07C 9/37; H04N 7/18

(52) U.S. Cl. CPC E06B 7/30; G06V 20/52; G06V 40/172; G07C 9/37; H04N 7/18

(57) ABSTRACT

Systems and methods for providing safety and security, and to aid hearing and/or mobility impaired individuals and users. The system may be an intelligent door screen system for providing safety and security. The system may include a camera configured to be attached to an outside of a door and configured to capture or receive images and/or video of an outside environment, and a color display screen configured to be attached to an inside of the door. The color display screen simultaneously displaying the images and/or the video of the outside environment to allow an occupant inside the door to view who or what is outside the door in real-time and give the occupant an appearance that he/she is looking outside the door through a window.

### CROSS REFERENCE TO RELATED APPLICATIONS

This application is based upon and claims the benefit of and priority to U.S. Provisional Application No. 63/529,929 entitled “INTELLIGENT DOOR SCREEN SYSTEM FOR PROVIDING SAFETY AND SECURITY,” filed on Jul. 31, 2023, the entire content of which is incorporated by reference herein.

### BACKGROUND

### 1. Field

The present disclosure relates generally to the field of home or office security, and more specifically to an intelligent door screen system for providing safety and security and to assist hearing impaired and/or mobility impaired individuals.

### 2. Description of the Related Art

Most homes, apartments, offices, and hotel rooms have a front door that separates the inside of the dwelling from the outside environment. When a visitor comes to the front door and rings the doorbell, one or more occupants inside the dwelling generally go to the front door and look through a peep hole to see who is there before opening the front door. The peep hole allows the one or more occupants to see the outside environment without being seen by the visitor outside. However, some drawbacks of peep holes are that the one or more occupants must come all the way to the front door to see who is outside and the visitor outside may also be able to see movement though the peep hole from the outside noticing that someone is inside the dwelling.

With the introduction of cell phones and mobile devices, cameras have been installed outside the front door, sometimes adjacent to the front door, to wirelessly connect to a network located in the home or office so that the network can then connect to a cell phone or mobile device of the one or more occupants. The cell phone or mobile device can be located anywhere, thus allowing the user to see who is outside the home or office at any time. However, one drawback of current systems is that if the network is unavailable or goes down, the cameras are unable to send the videos to the user(s) of the cell phones or mobile devices. In addition, another drawback is that the screens of cell phones and mobile devices are small and sometimes it is difficult to see object clearly. The outside camera can also be stolen very easily, thus preventing the user(s) of the cell phones or mobile devices the ability to see anything. An additional drawback is that the user(s) is required to have their device on them to see who or what is outside the door.

Accordingly, there is a need for a better and more efficient system for providing safety and security, and to aid hearing and/or mobility impaired individuals and users.

### SUMMARY

The present disclosure is directed to better and more efficient systems and methods for providing safety and security, and to aid hearing and mobility impaired individuals and users. An exemplary system may be an intelligent door screen system for providing safety and security, and to aid hearing and mobility impaired individuals and users. The system may include a camera configured to be attached to an outside of a door and configured to capture or receive images and/or video of an outside environment, and a color display screen configured to be attached to an inside of the door. The color display screen simultaneously displaying the images and/or the video of the outside environment to allow an occupant inside the door to view who or what is outside the door in real-time and give the occupant or user an appearance that he/she is looking outside the door through a window.

An intelligent door screen system for providing safety and security and assistance to aid hearing and/or mobility impaired individuals and users. The system includes an outside camera configured to be attached to a peephole of a door and configured to capture or receive images and/or video of an outside environment, and a facial recognition/authentication camera configured to capture or receive images of a person outside the door, the facial recognition/authentication camera having a lower resolution than the outside camera. The system further includes a processor wirelessly or wire connected to the outside camera and the facial recognition/authentication camera and configured to perform facial recognition/facial authentication of the person outside the door and determine whether the person is authorized to enter for a specified date and time, and if so, the processor electronically and automatically unlocks a door lock on the door. The system further includes a color display screen configured to be attached to an inside of the door and connected to the outside camera via the peephole, the color display screen simultaneously displaying in real-time the images and/or the video of the outside environment to allow an occupant inside the door to view who or what is outside the door and give the occupant an appearance that he/she is looking outside the door through a window.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the following illustrative figures. In the following figures, like reference numbers refer to similar elements and steps throughout the figures.

FIG. 1 is an inside view (left) and an outside view (right) of a door showing application of an intelligent door screen system in order to provide safety, security, and assistance to occupants within a dwelling according to various aspects of the invention.

FIG. 2 is a cross-sectional side view of the intelligent door screen system of FIG. 1 showing various components or features according to various aspects of the invention.

FIG. 3 is a block diagram of the intelligent door screen system of FIG. 2 showing various components or features according to various aspects of the invention.

Other systems, methods, features, and advantages of the present invention will be or will become apparent to one of ordinary skill in the art upon examination of the following figures and detailed description.

### DETAILED DESCRIPTION

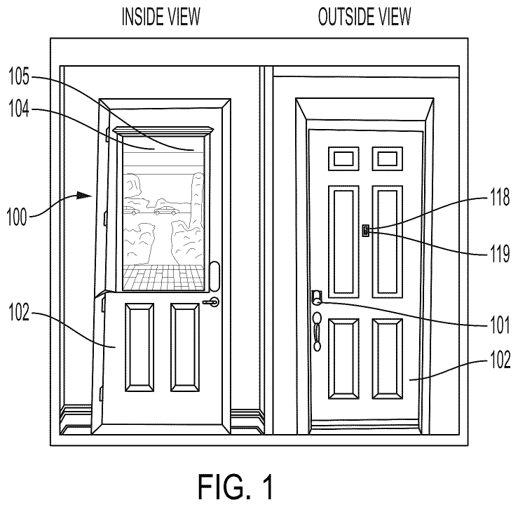

FIG. 1 is an inside view (left) and an outside view (right) of a door 102 showing application of an intelligent door screen system 100 in order to provide safety, security, and assistance to occupants within a dwelling according to various aspects of the invention. The inside view and the outside view show the same door as seen from the inside and the outside, respectively. The inside view shows a color display screen 104 mounted to the inside of a door 102, and a processor 105 integrated with or positioned adjacent to or within the color display screen 104. The outside view shows an outside camera 118 positioned on the outside of the door 102 and in wireless or wired communication with the color display screen 104 and the processor 105. Hence, the color display screen 104 and the outside camera 118 are positioned adjacent to one another and on opposite sides of the door 102. The outside camera 118 may also be positioned within the door 102 and directed outward to view the outside surroundings. The processor 105 is in wireless or wired communication with the color display screen 104.

The color display screen 104, the processor 105 and the outside camera 118 are Bluetooth, and/or WiFi enabled, and may also use Z-wave, Zigbee technology to wirelessly communicate and transfer (i.e., receive and transmit) data. In various aspects, the processor 105 can be a video, AI, edge computing, graphics, or micro processing chip or a computer chip for receiving data (e.g., images and/or video) from the outside camera 118 (e.g., 4k or 8k camera), processing the data, and transmitting and/or sending the data to the color display screen 104 for display as high-resolution images and/or video. The processor 105 may be wirelessly or wire connected between the color display screen 104 and the outside camera 118. The processor 105 is capable and configured to process large amounts of image and video data in real-time and immediately cause the data to be displayed on the color display screen 104 so as to give the inside occupants an appearance that they are looking out of a clear window that is located on the door 102.

The door 102 is generally rectangular in shape, and has a substantially flat outside surface and a substantially flat inside surface that is substantially parallel to the substantially flat outside surface. The door 102 may be a standard door used in a home such as a front door or a rear door to the home. The door 102 may have a door lock 101 that is electronically controlled by the processor 105. The door lock 101 can be locked and unlocked by the processor 105. In addition, the processor 105 can also automatically open and close the door 102 by controlling the hinges on the door 102 to aid hearing and/or mobility impaired individuals and users.

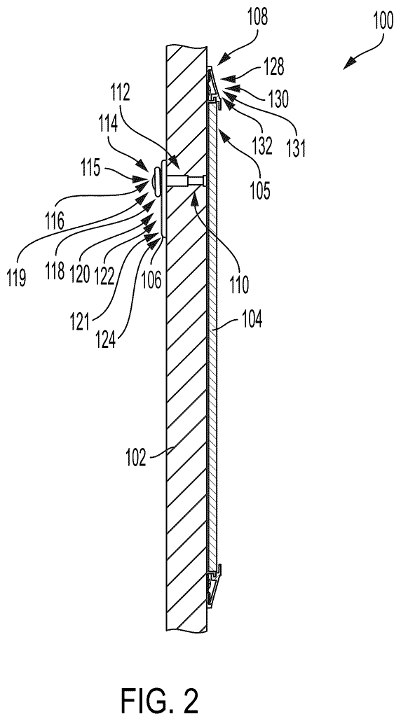

The outside camera 118 may be mounted within, to or on the exterior of the door 102 and may fit within or through a standard and/or adjustable peephole hole. The outside camera 118 can be attached to the door 102 and a connector or a cable can be fed through the door 102 (e.g., via a standard peephole camera tube and/or an adjustable peephole camera tube) to connect to the color display screen 104 and/or the processor 105. This allows for high quality 4k or 8k or higher resolution images and/or video (i.e., data) to be captured by the outside camera 118, processed by the processor 105, and sent or transmitted to the color display screen 104 for display. The outside camera 118 may have one or more lenses 116 (e.g., an adjustable camera lens to center and align images/video) (see also FIG. 2) to capture 3D images and/or video for viewing of and/or facial recognition/authentication of people, objects or things outside the door 102. A facial recognition/authentication camera 115 can be the same as the outside camera 118 or a separate camera positioned adjacent to the outside camera 118 and connected to the processor 105.

A LIDAR sensor 119 is an active remote sensing system or technology and can be used to precisely measure distance and movement outside the door 102. Additionally, the LiDAR sensor 119 can also be used for facial recognition/authentication of people, things, and/or weapons. The LiDAR sensor 119 can be part of the facial recognition/authentication camera 115 or any other camera or sensor (e.g., the outside camera 118) described herein or a stand-alone sensor connected to the processor 105.

As an example, the processor 105 may be configured or programmed by an occupant to allow a certain authorized person (e.g., a guest or relative) into the dwelling. The occupant would scan, take or provide a photo of the authorized person to the processor 105 and the dates and/or times when the authorized person can enter the dwelling. For example, a cleaning person can enter and be in the home from 8 am to 11 am on Wednesdays. The occupant can scan or take a photo of the authorized person using the inside camera 128 and enter the dates and times using the color display screen 104, which can be a touch screen. The prompts on the color display screen 104 will guide the occupant through the scanning and input process (i.e., the set up process).

Once set up, the outside camera 118 or the facial recognition/authentication camera 115 or LiDAR sensor 119 can capture the images and/or video of the person at the door 102 and then the processor 105 can perform facial recognition/facial authentication of the person and determine whether the person is authorized to enter, and if so, the processor 105 can electronically and automatically unlock the door lock 101 on the door 102. Once the person enters the home, the processor 105 can electronically and automatically send a lock signal to the door lock 101 to lock the door 102 for safety and security. This can also be useful for children coming home from school where the door 102 can be unlocked and locked using facial recognition/authentication of the child or children.

The outside camera 118 is configured to capture or receive images and/or video of the outside environment and simultaneously display the images and/or video on the color display screen 104 to allow occupants inside the door 102 to view who or what is outside the door 102 in real-time. Advantageously, the occupants inside the door 102 see or have a very clear appearance or view that they are looking through a large window that provides a very clear view of who or what is outside the door 102. The occupants inside the door 102 can see clearly (not distorted or skewed like a typical peephole or camera) who or what (e.g., people, things and/or animals) is outside the door 102 from a distant (e.g., 20-30 feet away) and at various angles, without having to approach or go close to the door 102. This advantageously allows occupants inside the door 102 to see who or what is outside from a distant in real-time. Otherwise, the occupants will miss seeing who or what is outside at that immediate time, only to possibly view a delayed recording on their phone, which will be too late. The people outside the door 102 see a normal solid door 102 and are unable to see the occupants inside the door 102. The door 102 is solid and provides protection (i.e., safety) from the outside environment and people.

The color display screen 104 is configured and sized to be rectangular and permanently affixed or attached to the inside of the door 102 so as to be integrated into or mounted on the door 102 and match the motif of the door 102. As shown in FIG. 1, the color display screen 104 may cover approximately 50% or greater of the inside of the door 102. For example, the color display screen 104 may extend from the top of a top door hinge to a door handle in height and may be a significant portion of the width of the door 102 similar to a size of a window on the door (see FIG. 1). The color display screen 104 is advantageously large, at least 36 inches in height and at least 24 inches in wide, to provide occupants with the appearance that they are looking through a large window to the outside in real-time (i.e., not delayed) and the ability to clearly see the color display screen 104 from a distance and identify people, objects, or things outside the door 102. The color display screen 104 is not a portable handheld device or screen that can be carried around throughout the dwelling from room to room.

The color display screen 104 can be a high resolution, high pixel screen (e.g., 4k or 8k or higher resolution LED panel) or touch screen mounted to the inside of the door 102 to simulate a clear window that allows the occupants inside the dwelling the ability to safely and securely see who or what is outside the door 102 without having to approach the door 102 or without having the risk of someone or something being able to break the window on the door 102. The outside camera 118 captures or provides an actual, undistorted view, of the outside of the dwelling while giving the occupants inside very clear and life-like images and video of the outside environment. Normally, when occupants hear a noise or a knock on the door 102, the occupants must travel to the door 102 to see who or what is outside. Sometimes, this time delay is too late to see who or what is outside. Similarly, other camera systems provide a notice to a cell phone but do not provide real-time viewing of the video. The intelligent door screen system 100 avoids this and allows occupants to view the outside from far away (e.g., across the room or on the other side of the house or office) without having to constantly go to the door 102 and look through a traditional peephole. Traditional peepholes also allow people from the outside to see and know when someone is looking through the peephole from the inside and this lack of security is a drawback of traditional peepholes.

Other systems, such as Ring®, sometimes have delays in seeing the video or who or what is outside due to delays (e.g., network, processor or processing delays) in transmission, reproduction, and/or storing of the video to or on the occupant's cell phone. Also, sometimes the videos freeze and are unable to be watched in their entireties. Hence, these systems generally do not provide actual, real-time videos but rather provide recorded, delayed, distorted and/or incomplete videos. In addition, cameras such as Ring® cameras, can be removed, destroyed, or stolen from the front of the house, whereas the outside camera 118 is typically secured from inside the door 102 and/or integrated into the door 102, thus making it very difficult for burglars to remove, or steal the outside camera 118.

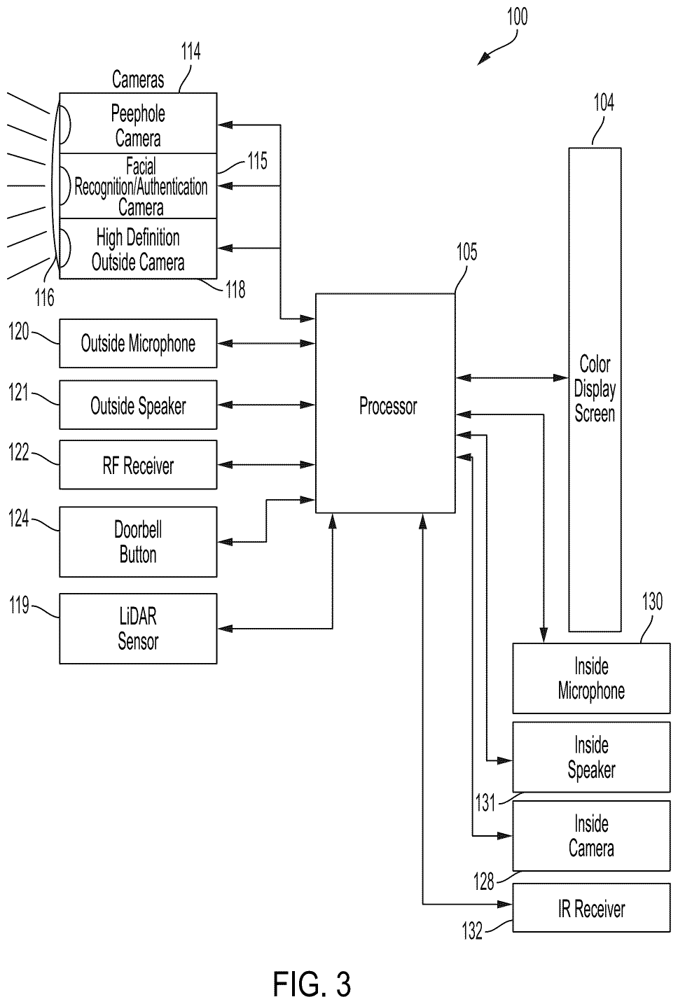

FIG. 2 is a cross-sectional side view of the intelligent door screen system 100 of FIG. 1 and FIG. 3 is a block diagram of the intelligent door screen system 100 of FIG. 2, both figures showing various components and features according to various aspects of the invention. Referring to FIGS. 2 and 3, the door screen system 100 may include one or more (in various different combinations) of the following components or elements: a color display screen 104, a processor 105, a peephole camera 114 having an adjustable camera lens 116, a facial recognition/facial authentication camera 115 (e.g., a LiDAR sensor), a standard peephole camera tube 112, an adjustable peephole camera tube 110, an exterior plate or housing 106, an outside camera 118, an outside microphone 120, an outside speaker 121, an RF sensor 122, an illuminated doorbell button 124, a casement trim 108 to secure the color display screen 104 to the door 102, an inside camera 128, an inside microphone 130, an inside speaker 131, and/or an inside IR receiver 132. The processor 105 may include or be coupled to the outside RF sensor 122, the inside IR receiver 132, and/or a memory or a cloud storage device to store the digital information such as, audio and/or video recordings and/or messages. The color display screen 104 and/or the processor 105 may be Wi-Fi, WiGig, and Bluetooth enabled, and utilize Z-wave and Zigbee technology.

The door screen system 100 can be installed on any door such as the door 102. The door 102 can be made of wood, metal, plastic, or a composite material. As an example, the color display screen 104 can be a 4k or 8k or higher resolution LED panel or touch screen mounted to the inside of the door 102. The door screen system 104 can be permanently mounted to the face of the inside of the door 102 or it can be integrated into the door 102. The color display screen 104 can switch from window mode (i.e., the display screen 104 show a view of the outside as if you were looking through a window) to mirror mode (i.e., the display screen 104 acts as a mirror) and vice versa using the color display screen 104 as a touch screen or voice commands using the inside microphone 130. The user may need to say “switch to window mode” or “switch to mirror mode”.

The inside camera 128 may have facial recognition/authentication and may be utilized to record messages that can be played back to specific or multiple individuals when their face is recognized by the inside camera 128. The occupants from inside the dwelling can audibly initiate a two-way conversation with a person outside the door 102. The inside camera 128 is capable of detecting and recognizing hand gestures that allows the occupant(s) to silently activate the exterior microphone 120 allowing the occupant(s) inside the dwelling the ability to listen to what's going on outside the door 102 using the inside speaker 131. The inside speaker 131 may be portable so it can be taken 20-30 feet away from the color display screen 104 so the occupant can be far away, thus avoiding the person outside the door 102 from knowing someone is listening. The occupant(s) inside a dwelling, for example, can clearly and easily view the color display screen 104 from a distant, e.g., 20-30 feet or more away from the door 102, so as to view who or what is outside the door 102 and can hear what is going on outside via the inside speaker 131.

An advantage of the large color display screen 104 is that the occupants get an actual, real-life, real-time view/video of the outside surroundings as if they were looking outside through a window. The color display screen 104 faces the inside of the dwelling. The color display screen 104 can be made from an impact resistant protective glass or have a shield or screen covering the color display screen 104 in order to protect against an occupant getting injured if he or she runs into the color display screen 104. A unique feature is that the color display screen 104 is at the door 102 while the inside speaker 131 can be with the occupant, remotely travelling through the home. The inside speaker 131 can be a set of wireless headphones wirelessly (e.g., Bluetooth) connected to the processor 105 and/or the color display screen 104. This advantageously allows the occupant to hear and see what is outside in a private manner using the headphones without having other occupants hear what is outside.

The standard peephole camera tube 112 can be positioned through the door 102 in a horizontal direction. If the thickness of the door 102 is greater than the length of the standard peephole camera tube 112, an adjustable peephole camera tube 110 may be inserted adjacent to the standard peephole camera tube 112 to accommodate for different door thicknesses. The standard peephole camera tube 112 and the adjustable peephole camera tube 110 are positioned along the same horizontal axis to allow for the peephole camera 114, the facial recognition/authentication camera 115, and/or the outside camera 118 to fit therethrough. The peephole camera 114, the facial recognition/authentication camera 115, and the outside camera 118 can be one or more separate cameras 118. The adjustable peephole camera tube 110 can be adjustable to have variable lengths so that the combination of the standard peephole camera tube 112 and the adjustable peephole camera tube 110 extend the entire door thickness. An electrical connector can be used to connect the outside camera 118 to the processor 105 and/or the color display screen 104 via the standard peephole camera tube 112 and/or the adjustable peephole camera tube 110.

The peephole camera 114 is generally positioned in line with, adjacent to, above, or below, the standard peephole camera tube 112 and has an adjustable camera lens 116 to center and align the images and/or videos. The adjustable camera lens 116 is aimed or directed towards the outside environment. The occupants can adjust the adjustable camera lens 116 to obtain the desired view, image or video on the color display screen 104. The peephole camera 114 and the adjustable camera lens 116 are weatherproof or weather tight. The images or videos captured by the peephole camera 114 can be used with the processor 105 for facial recognition/authentication of the visitors, guests and occupants. The AI technology the processor 105 uses is able to detect things, such as, people, weapons and animals. In addition, the AI technology the processor 105 can also detect aggressive behaviors or motions. The AI technology can also be trained to recognize or detect other objects, events or people and then trigger an event on another device or system. The visitor, guest or occupant can leave a message via the outside microphone 120 and/or a video via the peephole camera 114, which is automatically emailed or texted to the one or more occupants or owners of the dwelling. The occupant and the guest can also have a conversation using the microphone and speaker combinations.

In various configurations and aspects, the door screen system 100 may include an exterior plate or housing 106 containing or having an outside camera 118, an outside microphone 120, an outside speaker 121, an outside RF sensor 122, and/or an illuminated doorbell button 124. The outside camera 118 may be in addition to or in lieu of the peephole camera 114. The outside camera 118 can be configured to perform all the functions of the peephole camera 114 and the facial recognition/authentication camera 115. In some aspects, the outside camera 118 may be a higher quality camera than the peephole camera 114 to provide clearer and higher detailed images and/or videos on the color display screen 104. The outside camera 118 may be a 4k or 8k or higher resolution camera. The LiDAR sensor 119 may be in addition to the facial recognition/authentication camera 115 and used to track motion or depth in the image or video. The illuminated doorbell button 124, when pressed, may be used to initiate or activate a doorbell located inside the dwelling.

In various configurations and aspects, the door screen system 100 may include a casement trim 108 that is located above and below the color display screen 104 and is used to secure the color display screen 104 to the door 102. The casement trim 108 may be used to hold or house an inside camera 128, an inside microphone 130, an inside speaker 131, and/or an inside IR receiver 132. The inside camera 128, the inside microphone 130, the inside speaker 131, and/or the inside IR receiver 132 can also be part of or connected to the color display screen 104.

The outside microphone 120 is used to detect audio noises or sounds from the outside environment and transmit those noises or sounds to the inside speaker 131. When an outside noise is detected, the processor 105 can alert the occupant/owner by audio, text, or email on a cell phone, for example. An example of this may be the sound of glass breaking, dog barking, a child crying, someone shouting, or a gun firing. The outside microphone 120 can also receive voices from the outside and pass the voices to the processor 105 for voice recognition. If the processor 105 recognizes the voice, and the voice is authorized to enter, the door lock 101 can be automatically unlocked. The voice recognition can also be used to greet guests or chase off unwanted persons.

The inside microphone 130 can detect voice command and specific instructions from the one or more occupants inside or owners of the dwelling. A voice command can also be used to unlock and/or open the door 102. For example, an authorized occupant can say “open the front door” to the outside microphone 120 and the processor 105 recognizing the voice can automatically unlock the door 102. For example, an occupant can provide functions such as change from window mode to mirror mode and vice versa, follow messages such as only allow John to enter, and lock and unlock the door 102. In various aspects, the voice recognition system, located within the processor 105, would only follow voice commands from a select set of users as configured or programmed by the owner or renter of the dwelling. The color display screen 104 and/or the processor 105, using voice commands, can be programmed to have one or more authorized users. Two-factor authentication can also be used to ensure that any programming or commands are performed by authorized users only.

The outside RF sensor 122 or LiDAR sensor 119, coupled to the outside camera 118, may be used to transmit the images and/or the video captured by the outside camera 118 to the processor 105, and/or the color display screen 104. The RF sensor 122 or the LiDAR sensor 119 can be used to detect motion or movement outside the door 102, and send information to the processor 105 to alert the occupant/owner by audio, app, text, or email. The RF sensor 122 and the LiDAR sensor 119 can be utilized to trigger events such as, audio and video recordings, trigger smart devices, such as, smart lights, or smart doorbells. The inside IR receiver 132 may be utilized to access the processor 105 to make adjustments to the hardware using an IR remote control or keyboard. The inside camera 128 may be used to capture images and/or a video of the inside of the dwelling and send them to the processor 105 and may transmit these images and/or video to a mobile device of the occupant(s) to determine and detect when intruders and/or people enter through the door 102. The inside camera 128 can capture images and/or a video of the one or more occupants using hand gestures or sign language for activating and deactivate features (e.g., locking and unlocking of the door 102, starting and ending the intercom mode, etc.). Sign language recognition can be used as an alternative to voice command inputs. Similarly, the inside microphone 130 (can also be part of wireless headphones) can capture voice commands from one or more occupants for activating and deactivate features (e.g., locking and unlocking of the door 102, starting and ending the intercom mode, communicating with someone outside the door 102 via the outside microphone 120, outside speaker 121, etc.).

In addition, the intelligent door screen system 100 can operate using sign-language recognition, sign-language to speech for accessibility using the inside camera 128 and/or the outside camera 118 and can receive sign-language on the outside camera 118 and convert the signs to voice and/or text on the color display screen 104. The color display screen 104 can display live auto-captions for speech from outside for deaf and hard of hearing users.

The intelligent door screen system 100 and the components described herein utilize various technologies, including, but not limited to, Wi-Fi, WiGig, Hub, Bluetooth, ZigBee, Z-Wave, Z-Wave Plus, Thread, mesh networks, AI, wireless and wired communications, biometrics, 2-factor authentication, power transfer technology, web-based applications, downloadable applications, etc. The AI can be used for voice recognition, voice commands, facial recognition/authentication, weapon detection, motion detection, text to speech, voice to text, machine learning, electronic door locks, warning messages, guest introductions, recordations, leaving messages for a particular person based on facial recognition/authentication or voice recognition, delivery of audio, video, text, or voice messages, etc.

Exemplary embodiments of the systems and methods have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. An intelligent door screen system for providing safety and security and assistance, comprising:
an outside camera configured to be attached to a peephole of a door and configured to capture or receive images and/or video of an outside environment; and
a color display screen configured to be attached to an inside of the door and connected to the outside camera via the peephole, the color display screen simultaneously displaying in real-time the images and/or the video of the outside environment to allow an occupant inside the door to view who or what is outside the door and give the occupant an appearance that he/she is looking outside the door through a window.

2. The intelligent door screen system of claim 1 further comprising one or more lenses positioned on or about the outside camera to focus and align the images and/or the video of the outside environment.

3. The intelligent door screen system of claim 1 further comprising a facial recognition/authentication camera coupled to the color display screen for viewing of and/or facial recognition/authentication of people, objects and things outside the door.

4. The intelligent door screen system of claim 1 further comprising a processor wirelessly or wire connected to the outside camera and the color display screen and configured to process the images and/or the video prior to display on the color display screen.

5. The intelligent door screen system of claim 4 further comprising a LiDAR sensor coupled to the color display screen and configured to detect motion or movement outside the door and transmit information to the processor to alert the occupant by audio, app, text, or email.

6. The intelligent door screen system of claim 4 further comprising wireless headphones wirelessly connected to the processor or the color display screen to allow the occupant to hear what is outside in a private manner.

7. The intelligent door screen system of claim 1 further comprising an inside microphone configured to detect voice command and specific instructions from the occupant.

8. The intelligent door screen system of claim 1 wherein the color display screen is in the shape of a rectangle and positioned such that a height is greater than a width and is mounted to the door to give an appearance that the color display screen is a window.

9. The intelligent door screen system of claim 1 wherein the color display screen is sized to cover a substantial portion of the inside of the door to simulate a clear window that allows the occupants inside the door the ability to safely and securely see who or what is outside the door without having to approach the door.

10. The intelligent door screen system of claim 1 further comprising a peephole camera tube positioned through the door in a horizontal direction and wherein the outside camera fits at least partially within the peephole camera tube.

11. The intelligent door screen system of claim 1 wherein the color display screen is at least, 36 inches in height and at least 24 inches in width to give the occupant an appearance that he/she is looking outside the door through a window.

12. An intelligent door screen system for providing safety and security and assistance to aid hearing and/or mobility impaired individuals and users, the system comprising:
an outside camera configured to be attached to a peephole of a door and configured to capture or receive images and/or video of an outside environment;
a facial recognition/authentication camera configured to capture or receive images of a person outside the door, the facial recognition/authentication camera having a lower resolution than the outside camera;
a processor wirelessly or wire connected to the facial recognition/authentication camera and configured to perform facial recognition/facial authentication of the person outside the door and determine whether the person is authorized to enter for a specified date and time, and if so, the processor electronically and automatically unlocks a door lock on the door; and
a color display screen configured to be attached to an inside of the door and connected to the outside camera via the peephole, the color display screen simultaneously displaying in real-time the images and/or the video of the outside environment to allow an occupant inside the door to view who or what is outside the door and give the occupant an appearance that he/she is looking outside the door through a window.

13. The intelligent door screen system of claim 12 further comprising one or more lenses positioned on or about the outside camera to focus and align the images and/or the video of the outside environment.

14. The intelligent door screen system of claim 12 wherein the processor is wirelessly or wire connected to the outside camera and the color display screen and configured to process the images and/or the video prior to display on the color display screen.

15. The intelligent door screen system of claim 12 further comprising a LiDAR sensor coupled to the color display screen and configured to detect motion or movement outside the door and transmit information to the processor to alert the occupant by audio, app, text, or email.

16. The intelligent door screen system of claim 12 further comprising wireless headphones wirelessly connected to the processor or the color display screen to allow the occupant to hear what is outside in a private manner.

17. The intelligent door screen system of claim 12 further comprising an inside microphone configured to detect voice command and specific instructions from the occupant.

18. The intelligent door screen system of claim 12 wherein the color display screen is sized to cover a substantial portion of the inside of the door to simulate a clear window that allows the occupants inside the door the ability to safely and securely see who or what is outside the door without having to approach the door.

19. The intelligent door screen system of claim 12 further comprising a peephole camera tube positioned through the door in a horizontal direction and wherein the outside camera fits at least partially within the peephole camera tube.

20. The intelligent door screen system of claim 12 wherein the color display screen is at least, 36 inches in height and at least 24 inches in width to give the occupant an appearance that he/she is looking outside the door through a window.
